(19) United States
(12) Patent Application Publication
(10) Pub. No.: US 2025/0076062 A1
(43) Pub. Date: Mar. 6, 2025

(54) HAZARDOUS FLEET DRIVING CONDITIONS DETECTION SYSTEM

(71) Applicant: Textron Inc., Providence, RI (US)

(72) Inventors: Russell William King, Evans, GA (US); Jonathan Daniel Bowen, North Augusta, SC (US); Gregory August Theodosakis, Augusta, GA (US)

(73) Assignee: Textron Inc., Providence, RI (US)

(21) Appl. No.: 18/459,098

(22) Filed: Aug. 31, 2023

(51) Int. Cl. G01C 21/34; B60W 50/12

(52) U.S. Cl. CPC G01C 21/3461; B60W 50/12; B60W 2520/105

(57) ABSTRACT

A method includes receiving operational data from a plurality of vehicles comprising a fleet of vehicles operating in an area of interest, the operational data indicating a motion and a corresponding location of the vehicle; processing the received operational data to identify events of interest, wherein each of the identified events of interest has an event type and has associated therewith a geographic area in which the event of interest occurred; and identifying clusters of the events of interest, wherein each of the clusters comprises multiple occurrences of ones of the events of interest having the same type and having associated therewith the same geographic area. A responsive action to mitigate operating conditions associated with the event type of the events of interest of the at least one of the identified clusters may subsequently be taken.

### TECHNICAL FIELD

This disclosure relates in general to the field of lightweight utility vehicles, such as golf carts and, more particularly, though not exclusively, to a system for detecting hazardous driving conditions in connection with a fleet of such vehicles.

### BACKGROUND

Presently, fleet management systems for lightweight utility vehicles, such as golf carts, allow for geofencing to be defined by a human operator (e.g., a manager) of a campus (e.g., a golf course) on which a fleet of vehicles operates. Limitations on operations permitted to be performed by fleet vehicles within a particular geofenced area may be determined by the operator based on his or her experience, as well as his or her familiarity with the geography and topography of the campus. Such operational limitations may include limiting the speed of a vehicle, disabling forward motion of a vehicle, disabling any motion of a vehicle, providing audible alerts using a speaker of the vehicle, and providing text, graphics, and/or video messages on a vehicle display. Present systems do not include the ability for the fleet to provide telemetry feedback to the campus operator to facilitate determinations of appropriate geofence operational limitations. Moreover, present systems do not provide any way to confirm the effectiveness (or lack thereof) of the limitations over time.

### BRIEF DESCRIPTION OF THE DRAWINGS

To provide a more complete understanding of the present disclosure and features and advantages thereof, reference is made to the following description, taken in conjunction with the accompanying figures, in which like reference numerals represent like elements:

FIG. 1 illustrates a lightweight utility vehicle that may be part of a fleet in connection with which embodiments described herein for a hazardous fleet driving conditions detection system may be implemented;

FIG. 2 illustrates a system block diagram of an example system for detecting hazardous fleet driving conditions according to features of embodiments described herein;

FIG. 3 illustrates a block diagram showing a number of different types of hazardous driving conditions that may be encountered by vehicles of a fleet of vehicles according to features of embodiments described herein;

FIG. 4 is a flowchart illustrating example operations performed by a system for detecting hazardous fleet driving conditions according to features of embodiments described herein; and

FIG. 5 is a block diagram of an example computer system that may be used to implement all or some portion of a system for detecting hazardous fleet driving conditions according to features of embodiments described herein.

### DETAILED DESCRIPTION

The following disclosure describes various illustrative embodiments and examples for implementing the features and functionality of the present disclosure. While particular components, arrangements, and/or features are described below in connection with various example embodiments, these are merely examples used to simplify the present disclosure and are not intended to be limiting. It will of course be appreciated that in the development of any actual embodiment, numerous implementation-specific decisions must be made to achieve the developer's specific goals, including compliance with system, business, and/or legal constraints, which may vary from one implementation to another. Moreover, it will be appreciated that, while such a development effort might be complex and time-consuming; it would nevertheless be a routine undertaking for those of ordinary skill in the art having the benefit of this disclosure.

In the specification, reference may be made to the spatial relationships between various components and to the spatial orientation of various aspects of components as depicted in the attached drawings. However, as will be recognized by those skilled in the art after a complete reading of the present disclosure, the devices, components, members, apparatuses, etc. described herein may be positioned in any desired orientation. Thus, the use of terms such as “above”, “below”, “upper”, “lower”, “top”, “bottom”, “raised”, “lowered”, or other similar terms to describe a spatial relationship between various components or to describe the spatial orientation of aspects of such components, should be understood to describe a relative relationship between the components or a spatial orientation of aspects of such components, respectively, as the components described herein may be oriented in any desired direction. When used to describe a range of dimensions or other characteristics (e.g., time, pressure, temperature, length, width, etc.) of an element, operations, and/or conditions, the phrase “between X and Y” represents a range that includes X and Y.

Additionally, as referred to herein in this specification, the terms “forward,” “aft,” “inboard,” and “outboard” may be used to describe relative relationship(s) between components and/or spatial orientation of aspect(s) of a component or components. The term “forward” may refer to a spatial direction that is closer to a front of a vehicle relative to another component or component aspect(s). The term “aft” may refer to a spatial direction that is closer to a rear of a vehicle relative to another component or component aspect(s). The term “inboard” may refer to a location of a component that is within the fuselage of a vehicle and/or a spatial direction that is closer to or along a centerline of the vehicle (wherein the centerline runs between the front and the rear of the vehicle) or other point of reference relative to another component or component aspect. The term “outboard” may refer to a location of a component that is outside the fuselage of a vehicle and/or a spatial direction that is farther from the centerline of the vehicle or other point of reference relative to another component or component aspect.

Further, the present disclosure may repeat reference numerals and/or letters in the various examples. This repetition is for the purpose of simplicity and clarity and does not in itself dictate a relationship between the various embodiments and/or configurations discussed. Example embodiments that may be used to implement the features and functionality of this disclosure will now be described with more particular reference to the accompanying figures.

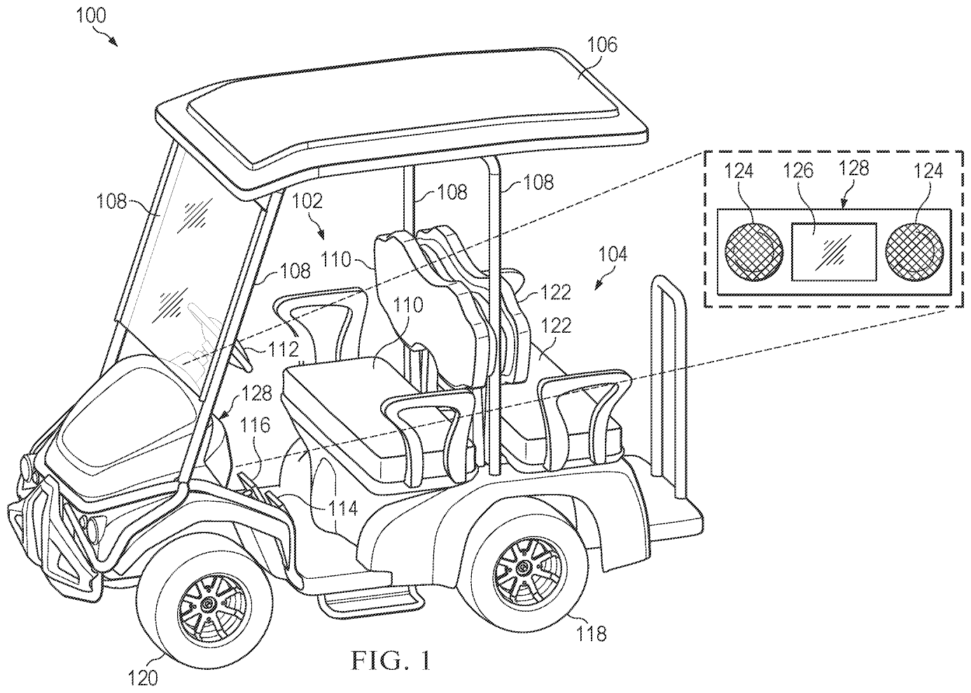

FIG. 1 illustrates a lightweight utility vehicle 100 that may be one of a fleet of such vehicles in connection with which embodiments described herein for a hazardous fleet driving conditions detection system may be implemented. In particular embodiments, vehicle 100 may be an electric vehicle. As shown in FIG. 1, vehicle 100 is generally an open cabin vehicle, such as a golf cart, a utility vehicle, a maintenance vehicle, a cargo vehicle, a shuttle vehicle, a personal transportation vehicle, etc., that includes a main passenger seating area 102, an auxiliary passenger seating area 104 disposed behind the main passenger seating area 102, and a canopy 106 primarily disposed over the main passenger seating area 102. Canopy 106 may be mounted to vehicle 100 and supported over (or above) main passenger seating area 102 via support struts 108. In particular embodiments support struts 108 may provide a roll over protection system (ROPS) for the vehicle 100.

The main passenger seating area 102 generally includes a primary seating structure 110, a steering wheel 112 for use by an operator (or driver) of the vehicle 100 to control the directional movement of the vehicle, a brake pedal 114 for use by the vehicle operator to control slowing and stopping of the vehicle, and an accelerator pedal 116 for use by the vehicle operator to control the torque delivered by one or more vehicle prime movers (not shown) to one or more rear wheels 118 and one or more front wheels 120. Auxiliary passenger seating area 104 generally includes an auxiliary seating structure 122 that can be attached to the rear portion of vehicle 100 behind primary seating structure 110 to provide additional seating capacity for the vehicle. More particularly, auxiliary seating structure 122 provides seating capacity in addition to that provided by the primary seating structure 110. Primary seating structure 110 is generally structured and operable to accommodate a vehicle operator and at least one passenger in a forward-facing (i.e., toward the front of vehicle 100) position, while auxiliary seating structure 122 is generally structured and operable to accommodate at least two passengers in a rearward-facing (i.e., toward the rear of vehicle 100) position. In particular embodiments, vehicle 100 includes one or more speakers 124 and a display 126, all of which may be provided on a dashboard 128 of vehicle 100. One or more controls associated with speakers 124 and display 126 may also be provided on or near dashboard 128.

In accordance with features of embodiments described herein, a fleet management system for a fleet of vehicles, of which vehicle 100 may be one, operating in a geographic area of interest, which may be referred to herein as campus, may acquire information regarding hazardous driving conditions, which may include hazardous driving events, experienced by the fleet of vehicles while operating on the campus. Such hazardous driving conditions may be a result of geographical and/or topological features of the campus, such as slopes, grades, water features, or other features, or may be the result of structures installed on the campus, such as curbs or roads having uneven surfaces or potholes. Such hazardous driving conditions may also be a result of other vehicles operating on the campus with which the vehicle may come into accidental contact. In particular embodiments, campus may be a private or otherwise restricted campus, such as a golf course.

In some embodiments, fleet management system may use the acquired information to automatically establish and/or modify corrective geofencing and/or other vehicle operational modifications in areas of the campus where high concentrations of hazardous driving conditions are detected over time. In particular embodiments, fleet vehicles may be equipped with devices, such as inertial measurement units (IMUs) that generate vehicle motion data indicative of operational situations that may be hazardous to the vehicle and/or vehicle occupants and thus comprise hazardous driving conditions. Such operational situations may include but are not limited to traversing steep slopes, traveling up or down steep grades, and impacts with stationary objects (e.g., trees, curbs, etc.) or moving objects (e.g., other vehicles). By using a fleet management system to remotely acquire and accumulate information regarding the occurrence, timing, and geographic location of such hazardous operational conditions over time, a heat map can be generated to identify areas where there is a significant concentration of hazardous driving conditions (i.e., hot spots). In some embodiments, the heat map may be analyzed to determine areas comprising emerging hot spots, of which the campus manager or fleet manager may be notified.

Using the heat map (and/or emerging hot spot notification), the campus manager (or fleet manager) can take steps to mitigate the identified hazardous driving situations, such as by posting appropriate signage, causing messages to be provided to vehicle drivers via vehicle speakers and/or displays, adding physical barriers and/or other modifications to the campus, and creating geofencing zones where operational limitations or restrictions (e.g., a maximum speed and/or acceleration) may be imposed on vehicles operating within the defined geofencing zone.

In particular embodiments, the fleet management system may employ machine learning algorithms or other techniques to automatically establish geofencing limitations (or other operational modifications) that adjust dynamically to reduce risk in areas identified as having a high concentrations of hazardous driving conditions. Such operational modifications may include reduction in the maximum speed at which a vehicle may operate in the area, increasing or decreasing regenerative braking force applied in the area, reducing vehicle acceleration in the area, and activating vehicle stability functions in the area in an effort to mitigate the hazardousness of the operational condition.

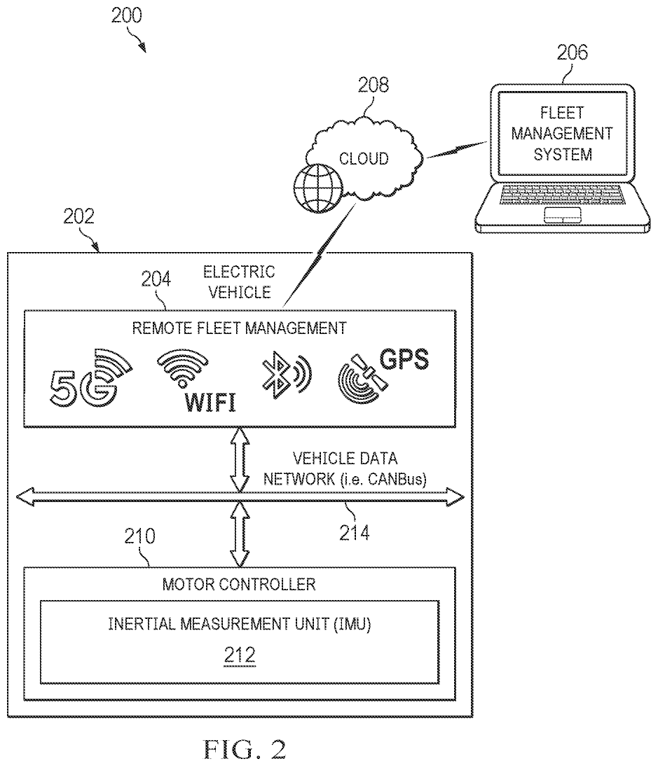

FIG. 2 illustrates a system block diagram of an example system 200 for detecting hazardous fleet driving conditions according to features of embodiments described herein. As shown in FIG. 2, system 200 includes a vehicle 202, which may be substantially identical to vehicle 100 (FIG. 1), comprising a remote fleet management module 204 for communicating with a remote fleet management system 206 in accordance with features of embodiments described herein via a cloud network 208, for example. In particular embodiments, 206 may be implemented as a web application executable on a computer device (including a mobile computer device) having an Internet connection. A motor controller 210 for controlling operation of vehicle 200 includes an IMU 212 and is connected to remote fleet management module 204 via a vehicle data network 214, which may be implemented as a controller area network (CAN) bus. In particular embodiments, motor controller 210 includes wheel speed sensors and other sensors for sensing various operational aspects of vehicle and providing data indicative of same to remote fleet management system 206. In alternative embodiments, IMU 212 could be deployed externally to controller 210; for example, IMU could be deployed internally to remote fleet management module 204 or another module of vehicle 200 or as a standalone module.

An IMU is an electronic sensing device that measures and reports the specific force, angular rate and/or orientation of a body on which it is installed. In particular embodiments, an IMU detects linear acceleration of the body using one or more accelerometers and rotational rate of the body using one or more gyroscopes. An IMU may also include one or more magnetometers for use as a heading reference. In a typical configuration, an IMU may include one accelerometer, one gyroscope, and one magnetometer per axis for each of three principal axes (e.g., pitch, roll, yaw (or x, y, z)). As used herein, IMU refers to any combination of accelerometers, gyroscopes and/or magnetometers that together perform the aforementioned purposes of an IMU. Integration of an IMU with a GPS and other sensors, such as a wheel speed sensor, provides the ability to gather data about the vehicle's current speed, turn rate, heading, inclination and acceleration, which data may collectively be referred to herein as “vehicle motion data.”

IMU 212 is capable of measuring acceleration in all three coordinate directions (pitch, roll, yaw or x, y, z) and angular speed about all three coordinates. The IMU data is combined with vehicle velocity data (e.g., provided by one or more sensors of motor controller 210) and providing resultant motion data to fleet management system 206 via remote fleet management module 204, enabling a variety of vehicle conditions to be determined and monitored by fleet management system 206. Additionally, global positioning system (GPS) capabilities of remote fleet management module 204 enable IMU motion data to be correlated to a GPS location, which location information is also provided to remote fleet management system 206. Location information combined with vehicle motion data (comprising IMU data and vehicle velocity data) may be processed to determine geographic areas that may result in operational hazards to vehicle 200, as well as other vehicles in a fleet, as described in greater detail below. In particular embodiments, remote fleet management system 206 may include a database or other repository for storing IMU measurement and related data.

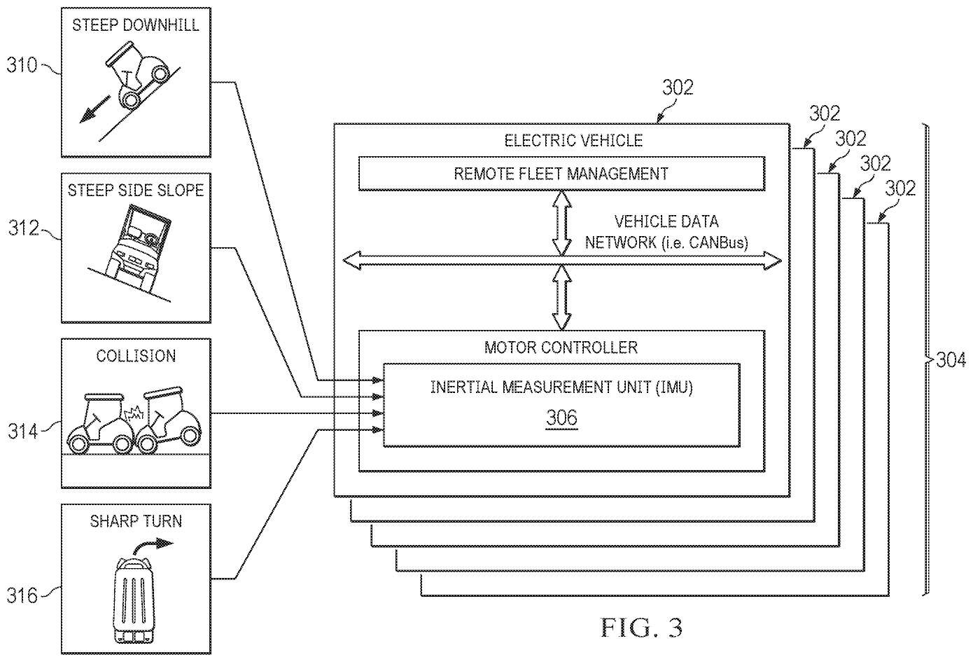

Referring now to FIG. 3, in particular embodiments, each vehicle 302 of a fleet of vehicles 304 connected to a remote fleet management system, such as remote fleet management system 206 (FIG. 2), may have installed thereon an IMU 306 for providing IMU data for the vehicle to the remote fleet management system as described above. Vehicles 302 may be substantially identical to vehicle 200 (FIG. 2). As noted above, analysis of motion data and GPS data for a particular one of the vehicles 302 may indicate operation of the vehicle in hazardous or non-ideal situations, including on grades 310 or slopes 312 beyond the ability of the vehicle to safely navigate. Additionally, analysis of data for the vehicle may indicate that the vehicle was involved in a collision or other impact 314 or was required to make a sharp turn or corner 316. Other conditions or situations that can be detected from vehicle motion data include vehicle tip- or roll-over events and traversal of rough or bumpy terrain.

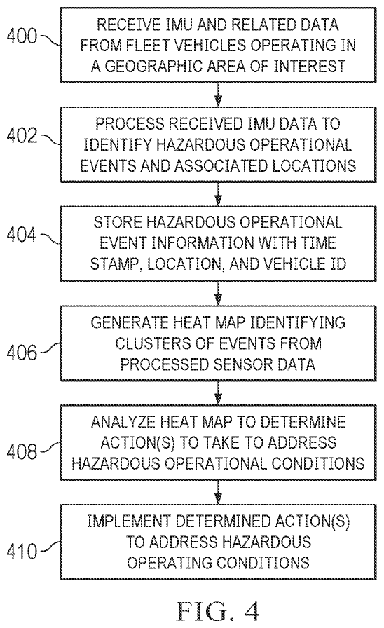

FIG. 4 is a flowchart illustrating example operations performed by a system for detecting hazardous fleet driving conditions according to features of embodiments described herein. In certain embodiments, one or more of the operations illustrated in FIG. 4 may be executed by one or more of the elements shown in FIG. 2, for example.

In operation 400, a fleet management system may receive from each vehicle of a fleet of vehicles controlled by the fleet management system vehicle motion data and corresponding GPS data indicative of operational conditions of the vehicle.

In operation 402, the received data may be periodically processed to identify hazardous operational conditions (or “events”) experienced by the vehicle. It will be recognized that the “type” of event (e.g., as illustrated in FIG. 3) may be determined in this operation such that events may be classified and/or filtered by type. In particular embodiments, certain types of events may be tagged as requiring substantially immediate attention; the campus manager (or fleet manager) may be notified substantially in real time regarding occurrence of such events (e.g., via fleet management system).

In operation 404, information for each detected event, which may include an indication of the event type, determined based on the processing operation (operation 402, the time and location at which the event occurred and the identity of the vehicle to which it occurred, may be stored as a record in a database or other storage device accessible by the fleet management system.

In operation 406, the records may be analyzed or otherwise processed to generate one or more heat maps for providing a visual indication of geographic areas in which there is a significant concentration of events. In particular embodiments, heat mapping may be overlaid on a map of the geographical area comprising the campus of interest. Such heat maps may provide an effective visual aid to a campus manager to enable him or her to take appropriate action to mitigate the occurrence of such events. In particular embodiments, the heat map may be filtered to focus on specific events, such as sharp turns or operation on steep slopes, to enable the mitigating actions to be more tailored based on the specific type of event. It will be recognized that other indicators of patterns of events, such as graphs and charts, for example, may be generated in addition to and/or in lieu of heat maps.

In operation 408, the heat map may be analyzed by either a human (such as campus manager or fleet manager) or an electronic device to determine one or more mitigating, remedial, or otherwise responsive steps or actions to be taken to address hazardous operating conditions associated with the event(s). For example, a geofence may be established or modified in an area having a high concentration of a particular type of event within which operational restrictions (e.g., a maximum operational speed and/or maximum rate of acceleration) maybe automatically imposed on the vehicle. Alternatively, appropriate signage may be displayed to alert vehicle operators to the potentially hazardous operating conditions. Still further, audio, text, and/or graphical messages regarding the potentially hazardous operating condition may be presented to the vehicle operator via the onboard speakers and/or display of a vehicle operating in an area in which a high concentration of a particular event has been detected. Additionally, the condition giving rise to the potentially hazardous operating condition may be corrected.

In operation 410, the determined mitigating or remedial steps may be implemented to address the hazardous operating conditions associated with the event(s).

Although the operations of the example method shown in and described with reference to FIG. 4 are illustrated as occurring once each and in a particular order, it will be recognized that the operations may be performed in any suitable order and repeated as desired. Additionally, one or more operations may be performed in parallel. Furthermore, the operations illustrated in FIG. 4 may be combined or may include more or fewer details than described.

In alternative embodiments, a machine learning (ML) or similar algorithm may be employed to identify locations corresponding to clusters of specific types of events and then apply predefined remedial or responsive actions (e.g., remediations) to mitigate the severity of and/or eliminate the occurrence of those events in the corresponding location. For example, high lateral G forces could be defined as indicating a sharp cornering event and an ML algorithm could be trained to identify clusters of such events based on an analysis of fleet vehicle data using the defined event criteria. A corresponding remediation could then be defined to address the event. In the present example, such a remediation may include reduction of the speed of a vehicle as the vehicle approaches the location of an identified cluster of sharp cornering events. The ML algorithm could continue to monitor the fleet motion data over time following implementation of the remediation to determine the effectiveness of the remediation. If it is determined based on the subsequent monitoring that the remediation is not sufficiently effective, the ML algorithm could further reduce the speed of fleet vehicles as they approach the sharp cornering event cluster location until the subsequent fleet motion data monitoring demonstrates sufficient reduction in the sharp cornering events at that location.

In particular embodiments, operational restrictions implemented in response to an event may be reduced if they prove too restrictive. For example, an acceptable incident index target and/or threshold may be established for this purpose. By way of illustration, assuming 0% equates to no likelihood of incident (i.e., occurrence of the event of interest) and 100% equates to an extremely high likelihood of incident, an operational restriction comprising a geofence enforcing a 10 mph speed limit may initially be defined for an area in which there is a 30% likelihood of incident, which geofence reduces the likelihood of incident to 0%. It will be recognized that there may be events the incidents of which do not result in an unacceptable risk to vehicle operators, in which case, it may not be necessary to reduce the likelihood of incident to 0%. In such situations, the operational restriction may be deemed too restrictive and it may make sense to relax the restriction somewhat (e.g., the speed limit within the geofenced area may be raised from 10 mph to 12 mph) unless and/or until an acceptable incident target (e.g., 10%) is achieved. It will be recognized that the incident target or other metrics may be used to adjust the operational restriction to make the restriction more or less restrictive over time.

Additionally and/or alternatively, the fleet motion data (which may be defined to include corresponding GPS data) collected by the fleet management system may be used for other purposes, such as to assign a depreciation value (i.e., a value after depreciation of the vehicle) and/or remaining useful life of the vehicle based on the number and/or types of events experienced by the vehicle. For example, a vehicle that has undergone a roll-over event likely has a lower depreciation value and/or shorter remaining useful life than a vehicle that has not undergone a roll-over event.

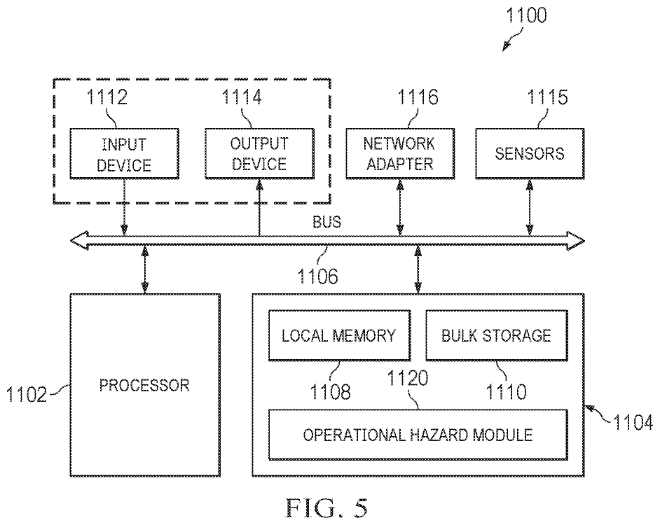

FIG. 5 is a block diagram illustrating an example system 1100 that may be configured to implement at least portions of techniques in accordance with embodiments described herein, and more particularly as shown in the FIGURES described hereinabove. As shown in FIG. 5, the system 1100 may include at least one processor 1102, e.g., a hardware processor 1102, coupled to memory elements 1104 through a system bus 1106. As such, the system may store program code and/or data within memory elements 1104. Further, the processor 1102 may execute the program code accessed from the memory elements 1104 via a system bus 1106. In one aspect, the system may be implemented as a computer that is suitable for storing and/or executing program code. It should be appreciated, however, that the system 1100 may be implemented in the form of any system including a processor and a memory that is capable of performing the functions described in this disclosure.

In some embodiments, the processor 1102 can execute software or an algorithm to perform the activities as discussed in this specification; in particular, activities related to embodiments described herein. The processor 1102 may include any combination of hardware, software, or firmware providing programmable logic, including by way of non-limiting example a microprocessor, a DSP, a field-programmable gate array (FPGA), a programmable logic array (PLA), an integrated circuit (IC), an application specific IC (ASIC), or a virtual machine processor. The processor 1102 may be communicatively coupled to the memory element 1104, for example in a direct-memory access (DMA) configuration, so that the processor 1102 may read from or write to the memory elements 1104.

In general, the memory elements 1104 may include any suitable volatile or non-volatile memory technology, including double data rate (DDR) random access memory (RAM), synchronous RAM (SRAM), dynamic RAM (DRAM), flash, read-only memory (ROM), optical media, virtual memory regions, magnetic or tape memory, or any other suitable technology. Unless specified otherwise, any of the memory elements discussed herein should be construed as being encompassed within the broad term “memory.” The information being measured, processed, tracked or sent to or from any of the components of the system 1100 could be provided in any database, register, control list, cache, or storage structure, all of which can be referenced at any suitable timeframe. Any such storage options may be included within the broad term “memory” as used herein. Similarly, any of the potential processing elements, modules, and machines described herein should be construed as being encompassed within the broad term “processor.” Each of the elements shown in the present figures may also include suitable interfaces for receiving, transmitting, and/or otherwise communicating data or information in a network environment so that they can communicate with, for example, a system having hardware similar or identical to another one of these elements.

In certain example implementations, mechanisms for implementing embodiments as outlined herein may be implemented by logic encoded in one or more tangible media, which may be inclusive of non-transitory media, e.g., embedded logic provided in an ASIC, in DSP instructions, software (potentially inclusive of object code and source code) to be executed by a processor, or other similar machine, etc. In some of these instances, memory elements, such as e.g., the memory elements 1104 shown in FIG. 5 can store data or information used for the operations described herein. This includes the memory elements being able to store software, logic, code, or processor instructions that are executed to carry out the activities described herein. A processor can execute any type of instructions associated with the data or information to achieve the operations detailed herein. In one example, the processors, such as e.g., the processor 1102 shown in FIG. 5, could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., an FPGA, a DSP, an erasable programmable read-only memory (EPROM), an electrically erasable programmable read-only memory (EEPROM)) or an ASIC that includes digital logic, software, code, electronic instructions, or any suitable combination thereof.

The memory elements 1104 may include one or more physical memory devices such as, for example, local memory 1108 and one or more bulk storage devices 1110. The local memory may refer to RAM or other non-persistent memory device(s) generally used during actual execution of the program code. A bulk storage device may be implemented as a hard drive or other persistent data storage device. The processing system 1100 may also include one or more cache memories (not shown) that provide temporary storage of at least some program code in order to reduce the number of times program code must be retrieved from the bulk storage device 1110 during execution.

As shown in FIG. 5, the memory elements 1104 may store an operational hazard module 1120. In various embodiments, the module 1120 may be stored in the local memory 1108, the one or more bulk storage devices 1110, or apart from the local memory and the bulk storage devices. It should be appreciated that the system 1100 may further execute an operating system (not shown in FIG. 5) that can facilitate execution of the module 1120. The module 1120, being implemented in the form of executable program code and/or data, can be read from, written to, and/or executed by the system 1100, e.g., by the processor 1102. Responsive to reading from, writing to, and/or executing the module 1120, the system 1100 may be configured to perform one or more operations or method steps described herein.

Input/output (I/O) devices depicted as an input device 1112 and an output device 1114, optionally, may be coupled to the system. Examples of input devices may include, but are not limited to, a keyboard, a pointing device such as a mouse, or the like. Examples of output devices may include, but are not limited to, a monitor or a display, speakers, or the like. In some implementations, the system may include a device driver (not shown) for the output device 1114. Input and/or output devices 1112, 1114 may be coupled to the system 1100 either directly or through intervening I/O controllers. Additionally, sensors 1115 may be coupled to the system 1100 either directly or through intervening controllers and/or drivers.

In an embodiment, the input and the output devices may be implemented as a combined input/output device (illustrated in FIG. 5 with a dashed line surrounding the input device 1112 and the output device 1114). An example of such a combined device is a touch sensitive display, also sometimes referred to as a “touch screen display” or simply “touch screen.” In such an embodiment, input to the device may be provided by a movement of a physical object, such as, e.g., a stylus or a finger of a user, on or near the touch screen display.

A network adapter 1116 may also, optionally, be coupled to the system 1100 to enable it to become coupled to other systems, computer systems, remote network devices, and/or remote storage devices through intervening private or public networks. The network adapter may comprise a data receiver for receiving data that is transmitted by said systems, devices and/or networks to the system 1100, and a data transmitter for transmitting data from the system 1100 to said systems, devices and/or networks. Modems, cable modems, and Ethernet cards are examples of different types of network adapter that may be used with the system 1100.

Example 1 provides a method comprising receiving vehicle operational data from a plurality of vehicles comprising a fleet of vehicles operating in an area of interest, wherein the vehicle operational data for each of the vehicles indicates a motion and a corresponding location of the vehicle; processing the received vehicle operational data to identify events of interest, wherein each of the identified events of interest has an event type and has associated therewith a geographic area in which the event of interest occurred; and identifying clusters of the events of interest, wherein each of the clusters comprises multiple occurrences of ones of the events of interest having the same type and having associated therewith the same geographic area.

Example 2 provides the method of example 1, further comprising, for at least one of the identified clusters, implementing a responsive action to mitigate operating conditions associated with the event type of the events of interest of the at least one of the identified clusters.

Example 3 provides the method of example 1, further comprising generating a heat map of the identified clusters of the events of interest; and overlaying the heat map on a map of the area of interest.

Example 4 provides the method of example 1, wherein at least one of the identifying and the implementing is performed by a machine learning module.

Example 5 provides the method of example 1, wherein the responsive action comprises imposing restrictions on vehicle operations in a geofenced area of the area of interest.

Example 6 provides the method of example 5, wherein the restrictions comprise at least one of limiting a maximum speed of the vehicle, limiting a maximum acceleration of the vehicle, and providing a notification to an operator of at least one of the vehicles.

Example 7 provides the method of example 1, wherein the responsive action comprises notifying an operator of at least one of the vehicles of the driving conditions.

Example 8 provides the method of example 7, wherein the notifying comprises providing at least one of an audio alert via a speaker installed on the at least one of the vehicles; a text alert via a display installed on the at least one of the vehicles; and a graphic alert via the display installed on the at least one of the vehicles.

Example 9 provides the method of example 1, wherein the vehicle operational data comprises data generated by inertial measurement units (IMUs) installed on the vehicles.

Example 10 provides the method of example 1, wherein the processing further comprises creating for each of the identified events of interest a record identifying for the event of interest the event type, the geographic area in which the event of interest occurred, an identification of the vehicle in connection with which the event of interest occurred, and a time stamp indicative of a time at which the event of interest occurred.

Example 11 provides the method of example 10, further comprising analyzing the records to determine for each of the vehicles at least one of a depreciated value of the vehicle and a remaining useful life of the vehicle.

Example 12 provides the method of example 10, further comprising analyzing the records to detect that a hot spot is emerging in connection with the geographic area; and notifying a fleet manager of the detected emerging hot spot.

Example 13 provides the method of example 1, further comprising providing a substantially real-time notification to a fleet manager in connection with one of the events of interest.

Example 14 provides a system comprising a plurality of vehicles comprising a fleet of vehicles operating in an area of interest, each of the vehicles having installed thereon an inertial measurement device for generating motion data for the vehicle and having associated therewith a global positioning system (GPS) for generating location data for the vehicle; and a fleet management system for receiving the motion data and the location data for the vehicles, the fleet management system further configured to process the received motion data and location data to identify events of interest in connection with the vehicles, wherein each of the identified events of interest has an event type and has associated therewith a geographic location in which the event of interest occurred; identify clusters of the events of interest, wherein each of the clusters comprises multiple occurrences of ones of the events of interest having the same type and having associated therewith the same geographic location; and, for each of the identified clusters, determine a responsive action to mitigate operating conditions associated with the event type of the events of interest of the at least one of the identified clusters.

Example 15 provides the system of example 14, wherein the fleet management system is further configured to generate a heat map of the identified clusters of the events of interest; and overlay the heat map on a map of the area of interest.

Example 16 provides the system of example 14, wherein the responsive action comprises establishing a geofence in the geographic area of the identified cluster and imposing restrictions on vehicle operations within the geofence.

Example 17 provides the system of example 14, wherein the responsive action comprises providing a notification to an operator of at least one of the vehicles of the driving conditions, wherein the notification comprises at least one of an audio alert, a text alert, and a graphic alert.

Example 18 provides the system of example 14, wherein the vehicles comprise electric vehicles.

Example 19 provides the system of example 14, wherein the vehicles comprise lightweight utility vehicles operating on a closed campus.

Example 20 provides one or more non-transitory computer-readable storage media comprising instructions for execution which, when executed by a processor, are operable to perform operations comprising processing vehicle data generated by inertial measurement units (IMUs) and global positioning system (GPS) units installed on vehicles comprising a fleet of vehicles operating in an area of interest to identify occurrences of events, wherein each of the identified occurrences has associated therewith an event type and a geographic location; identifying clusters of the event occurrences, wherein each of the clusters comprises event occurrences having the same event type and geographic location; and, for each of the clusters, implementing a responsive action to mitigate operating conditions associated with the event type of the clusters.

Example 21 provides the one or more non-transitory computer-readable storage media of example 20, wherein the operations further comprise generating a heat map of the identified clusters of the events of interest; and overlaying the heat map on a map of the area of interest.

Example 22 provides the one or more non-transitory computer-readable storage media of example 20, wherein the responsive action comprises limiting a maximum speed of the vehicle in a geofenced area.

Example 23 provides the one or more non-transitory computer-readable storage media of example 20, wherein the responsive action comprises providing an audio, text, or graphic alert to an operator of at least one of the vehicles of the driving conditions.

At least one embodiment is disclosed, and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rl, and an upper limit, Ru, is disclosed, any number falling within the range is specifically disclosed. In particular, the following numbers within the range are specifically disclosed: R=Rl+k*(Ru−Rl), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . , 95 percent, 96 percent, 95 percent, 98 percent, 99 percent, or 100 percent. Moreover, any numerical range defined by two R numbers as defined in the above is also specifically disclosed. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present invention. Also, the phrases “at least one of A, B, and C” and “A and/or B and/or C” should each be interpreted to include only A, only B, only C, or any combination of A, B, and C. The terms “substantially,” “close,” “approximately,” “near,” and “about,” generally refer to being within +/−5-20% of a target value based on the context of a particular value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value based on the context of a particular value as described herein or as known in the art.

The diagrams in the FIGURES illustrate the architecture, functionality, and/or operation of possible implementations of various embodiments of the present disclosure. Although several embodiments have been illustrated and described in detail, numerous other changes, substitutions, variations, alterations, and/or modifications are possible without departing from the spirit and scope of the present disclosure, as defined by the appended claims. The particular embodiments described herein are illustrative only and may be modified and practiced in different but equivalent manners, as would be apparent to those of ordinary skill in the art having the benefit of the teachings herein. Those of ordinary skill in the art would appreciate that the present disclosure may be readily used as a basis for designing or modifying other embodiments for carrying out the same purposes and/or achieving the same advantages of the embodiments introduced herein. For example, certain embodiments may be implemented using more, less, and/or other components than those described herein. Moreover, in certain embodiments, some components may be implemented separately, consolidated into one or more integrated components, and/or omitted. Similarly, methods associated with certain embodiments may be implemented using more, less, and/or other steps than those described herein, and their steps may be performed in any suitable order.

Numerous other changes, substitutions, variations, alterations, and modifications may be ascertained to one of ordinary skill in the art and it is intended that the present disclosure encompass all such changes, substitutions, variations, alterations, and modifications as falling within the scope of the appended claims.

One or more advantages mentioned herein do not in any way suggest that any one of the embodiments described herein necessarily provides all the described advantages or that all the embodiments of the present disclosure necessarily provide any one of the described advantages. Note that in this specification, references to various features included in “one embodiment”, “example embodiment”, “an embodiment”, “another embodiment”, “certain embodiments”, “some embodiments”, “various embodiments”, “other embodiments”, “alternative embodiment”, and the like are intended to mean that any such features are included in one or more embodiments of the present disclosure but may or may not necessarily be combined in the same embodiments.

As used herein, unless expressly stated to the contrary, use of the phrase “at least one of,” “one or more of” and “and/or” are open ended expressions that are both conjunctive and disjunctive in operation for any combination of named elements, conditions, or activities. For example, each of the expressions “at least one of X, Y and Z”, “at least one of X, Y or Z”, “one or more of X, Y and Z”, “one or more of X, Y or Z” and “A, B and/or C” can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z. Additionally, unless expressly stated to the contrary, the terms “first,” “second,” “third,” etc., are intended to distinguish the particular nouns (e.g., blade, rotor, element, device, condition, module, activity, operation, etc.) they modify. Unless expressly stated to the contrary, the use of these terms is not intended to indicate any type of order, rank, importance, temporal sequence, or hierarchy of the modified noun. For example, “first X” and “second X” are intended to designate two X elements that are not necessarily limited by any order, rank, importance, temporal sequence, or hierarchy of the two elements. As referred to herein, “at least one of,” “one or more of,” and the like can be represented using the “(s)” nomenclature (e.g., one or more element(s)).

In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph (f) of 35 U.S.C. Section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

What is claimed is:

1. A method comprising:
receiving vehicle operational data from a plurality of vehicles comprising a fleet of vehicles operating in an area of interest, wherein the vehicle operational data for each of the vehicles indicates a motion and a corresponding location of the vehicle;
processing the received vehicle operational data to identify events of interest, wherein each of the identified events of interest has an event type and has associated therewith a geographic area in which the event of interest occurred; and
identifying clusters of the events of interest, wherein each of the clusters comprises multiple occurrences of ones of the events of interest having the same type and having associated therewith the same geographic area.

2. The method of claim 1, further comprising, for at least one of the identified clusters, implementing a responsive action to mitigate operating conditions associated with the event type of the events of interest of the at least one of the identified clusters.

3. The method of claim 1, further comprising:
generating a heat map of the identified clusters of the events of interest; and
overlaying the heat map on a map of the area of interest.

4. The method of claim 1, wherein at least one of the identifying and the implementing is performed by a machine learning module.

5. The method of claim 1, wherein the responsive action comprises imposing restrictions on vehicle operations in a geofenced area of the area of interest.

6. The method of claim 5, wherein the restrictions comprise at least one of limiting a maximum speed of the vehicle, limiting a maximum acceleration of the vehicle, and providing a notification to an operator of at least one of the vehicles.

7. The method of claim 1, wherein the responsive action comprises notifying an operator of at least one of the vehicles of the driving conditions.

8. The method of claim 7, wherein the notifying comprises providing at least one of:
an audio alert via a speaker installed on the at least one of the vehicles;
a text alert via a display installed on the at least one of the vehicles; and
a graphic alert via the display installed on the at least one of the vehicles.

9. The method of claim 1, wherein the vehicle operational data comprises data generated by inertial measurement units (IMUs) installed on the vehicles.

10. The method of claim 1, wherein the processing further comprises creating for each of the identified events of interest a record identifying for the event of interest the event type, the geographic area in which the event of interest occurred, an identification of the vehicle in connection with which the event of interest occurred, and a time stamp indicative of a time at which the event of interest occurred.

11. The method of claim 10, further comprising analyzing the records to determine for each of the vehicles at least one of a depreciated value of the vehicle and a remaining useful life of the vehicle.

12. The method of claim 10, further comprising:
analyzing the records to detect that a hot spot is emerging in connection with the geographic area; and
notifying a fleet manager of the detected emerging hot spot.

13. The method of claim 1, further comprising providing a substantially real-time notification to a fleet manager in connection with one of the events of interest.

14. A system comprising:
a plurality of vehicles comprising a fleet of vehicles operating in an area of interest, each of the vehicles having installed thereon an inertial measurement device for generating motion data for the vehicle and having associated therewith a global positioning system (GPS) for generating location data for the vehicle; and
a fleet management system for receiving the motion data and the location data for the vehicles, the fleet management system further configured to:
process the received motion data and location data to identify events of interest in connection with the vehicles, wherein each of the identified events of interest has an event type and has associated therewith a geographic location in which the event of interest occurred;
identify clusters of the events of interest, wherein each of the clusters comprises multiple occurrences of ones of the events of interest having the same type and having associated therewith the same geographic location; and
for each of the identified clusters, determine a responsive action to mitigate operating conditions associated with the event type of the events of interest of the at least one of the identified clusters.

15. The system of claim 14, wherein the fleet management system is further configured to:
generate a heat map of the identified clusters of the events of interest; and
overlay the heat map on a map of the area of interest.

16. The system of claim 14, wherein the responsive action comprises establishing a geofence in the geographic area of the identified cluster and imposing restrictions on vehicle operations within the geofence.

17. The system of claim 14, wherein the responsive action comprises providing a notification to an operator of at least one of the vehicles of the driving conditions, wherein the notification comprises at least one of an audio alert, a text alert, and a graphic alert.

18. The system of claim 14, wherein the vehicles comprise electric vehicles.

19. The system of claim 14, wherein the vehicles comprise lightweight utility vehicles operating on a closed campus.

20. One or more non-transitory computer-readable storage media comprising instructions for execution which, when executed by a processor, are operable to perform operations comprising:
processing vehicle data generated by inertial measurement units (IMUs) and global positioning system (GPS) units installed on vehicles comprising a fleet of vehicles operating in an area of interest to identify occurrences of events, wherein each of the identified occurrences has associated therewith an event type and a geographic location;
identifying clusters of the event occurrences, wherein each of the clusters comprises event occurrences having the same event type and geographic location; and
for each of the clusters, implementing a responsive action to mitigate operating conditions associated with the event type of the clusters.

21. The one or more non-transitory computer-readable storage media of claim 20, wherein the operations further comprise:
generating a heat map of the identified clusters of the events of interest; and
overlaying the heat map on a map of the area of interest.

22. The one or more non-transitory computer-readable storage media of claim 20, wherein the responsive action comprises limiting a maximum speed of the vehicle in a geofenced area.

23. The one or more non-transitory computer-readable storage media of claim 20, wherein the responsive action comprises providing an audio, text, or graphic alert to an operator of at least one of the vehicles of the driving conditions.
